(19) United States
(12) Patent Application Publication
(10) Pub. No.: US 2001/0015609 A1
(43) Pub. Date: Aug. 23, 2001

(54) Support frame for cathode-ray tube

(75) Inventors: Yong Hoon Choi, Kumi (KR); Jin Mok Park, Daegu (KR)

Correspondence Address: FLESHNER & KIM, P.O. Box 221200, Chantilly, VA, 20153-1200, US

(73) Assignee: LG Electronics Inc.

(21) Appl. No.: 09/782,031

(22) Filed: Feb. 14, 2001

(30) Foreign Application Priority Data
Feb. 17, 2000 (KR) 7554/2000

(51) Int. Cl. H01J 29/80

(52) U.S. Cl. 313/407; 313/402

(57) ABSTRACT

The present invention relates to a support frame for a cathode-ray tube which is capable of preventing damage of a corner portion of a support frame circumference in forming of the support frame. The support frame for supporting a shadow mask of a cathode-ray tube in accordance with the present invention comprises notches formed on a certain portion of an upper surface of the corner portion of the support frame circumference, in more detail on the longer side and shorter side of the support frame circumference.

### BACKGROUND OF THE INVENTION

1. Field of the Invention

The present invention relates to a support frame for a cathode-ray tube, in particular to a support frame for a cathode-ray tube which is capable of preventing damage of a corner portion of a support frame circumference in forming of the support frame.

2. Description of the Prior Art

As depicted in FIG. 1, a general cathode-ray tube comprises a panel 101 as a front window unit, a funnel 102 combined to the panel 101 as a rear surface window unit, an electron gun (not shown) built in a neck unit of the funnel 102 in order to radiate electron, a fluorescent screen 104 radiated by incidence of electron beam 106 radiated from the electron gun, a shadow mask 103 for selecting the incidence electron beam from the fluorescent screen 104, a support frame 107 for supporting the shadow mask 103, a spring 108 combining the support frame 107 to the panel 101, and an inner shield 109 fixed on the support frame 107 and performing outer earth magnetism shield function in order to reduce influence from the outer earth magnetism.

The electron beam 106 radiated from the electron gun by a positive voltage applied to the cathode-ray tube collides against the fluorescent screen 104 formed on the inner surface of the panel 101, the electron beam 106 is deflected to the up, down, left, right by a deflection yoke 105 placed on a neck unit of the funnel 102 before it reaches to the fluorescent screen.

In addition, a magnet 110 which modifies the electron beam proceed orbit for making the electron beam collide against a fluorescent material of the fluorescent screen 104 accurately is placed on the rear portion of the deflection yoke 105 in order to prevent color purity defect (abnormality of color purity).

Because the above-described cathode-ray tube is in high vacuum state, explosion can occur easily by impact from outside, in order to prevent it, a strengthening band 111 for dispersing stress of the cathode-ray tube in the high vacuum state is installed on the skirt portion of the panel 101, accordingly it is possible to improve the shock resistant performance.

Meanwhile, in forming of the support frame 107, as depicted in FIG. 2, when the shadow mask 103 is combined to the support frame 107, in order to increase operating efficiency, the outer end of the circumference (longer sides, shorter sides, diagonal portion) of the support frame 107 is extended outwardly in order to make the skirt portion of the shadow mask 103 and the circumference of the support frame 107 place on appropriate positions.

However, in the conventional cathode-ray tube, in order to make the combination of the shadow mask 103 and support frame 107 easier, as depicted in FIG. 3, when the outer end of the circumference of the support frame 107 is extended outwardly, the corner portion of the circumference of the support frame 107 can be damaged due to the stress on it.

### SUMMARY OF THE INVENTION

Accordingly, the object of the present invention is to provide a support frame for a cathode-ray tube which is capable of preventing damage of a corner portion of the circumference of a support frame in forming of the support frame.

In order to achieve the object of the present invention, the support frame for the cathode-ray tube in accordance with the present invention for supporting a shadow mask comprises a plurality of notches on a certain corner upper surface of the circumference of the support frame.

### BRIEF DESCRIPTION OF THE DRAWINGS

FIG. 1 is a partial sectional view illustrating a construction of a general cathode-ray tube.

FIG. 2 is a disassembling perspective view illustrating combination of the conventional support frame and shadow mask for a cathode-ray tube.

FIG. 3 illustrates damage of a corner portion of the support frame circumference in forming of the conventional cathode-ray tube.

FIG. 4 is a partial perspective illustrating a support frame for a cathode-ray tube in accordance with the present invention.

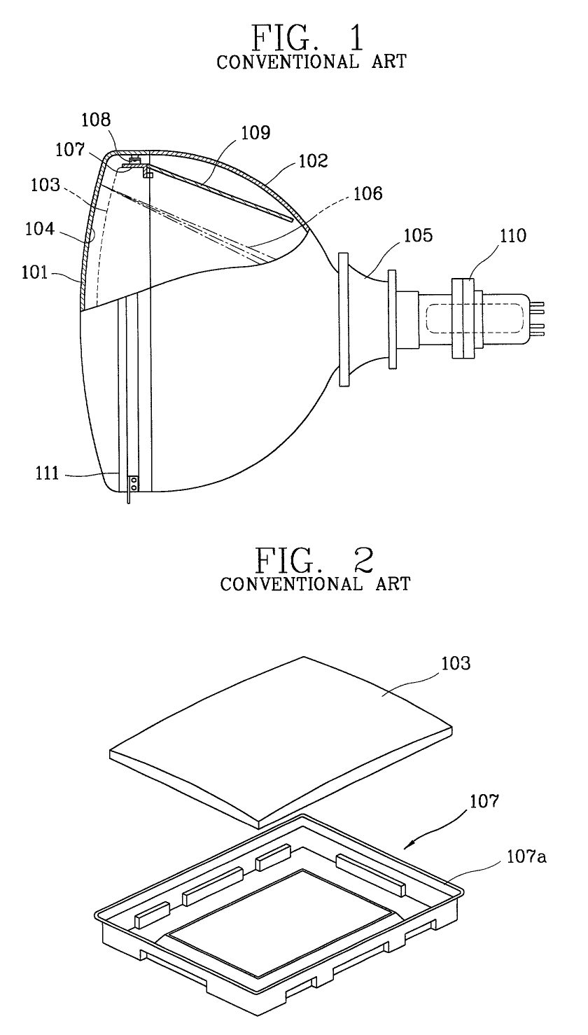

### DETAILED DESCRIPTION OF THE PREFERRED EMBODIMENT

Hereinafter, the preferred embodiment of a support frame for a cathode-ray tube in accordance with the present invention will now be described in detail with reference to accompanying drawings.

Descriptions about construction parts same with the conventional construction parts will now be abridged, in the construction of the support frame of the cathode-ray tube only the characteristic of the present invention will now be described.

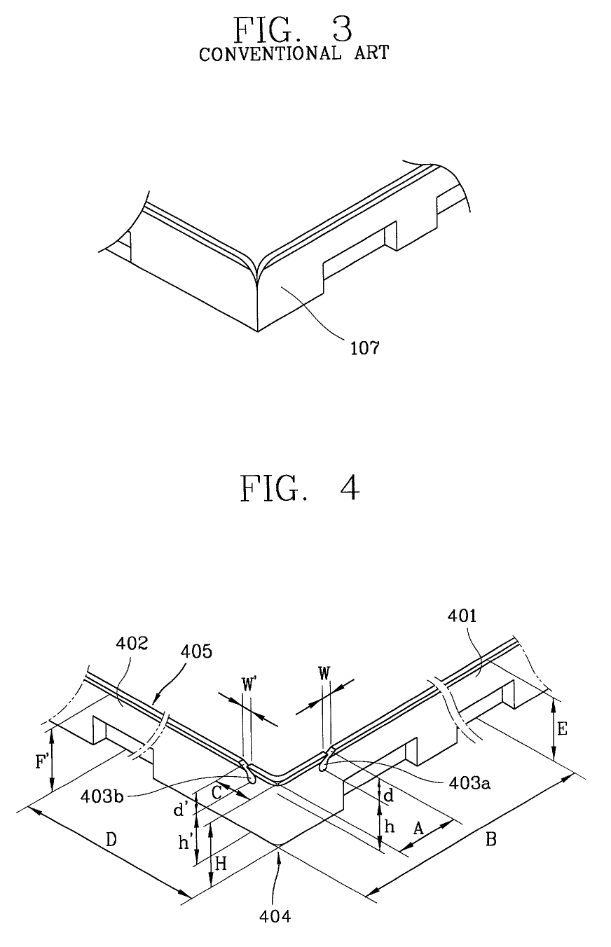

As depicted in FIG. 4, in the support frame for the cathode-ray tube in accordance with the present invention, a plurality of notches 403a, 403b are formed on a certain position of a corner portion 404 of a support frame circumference of the cathode-ray tube.

In more detail, the length from the corner portion 404 of the support frame circumference to the notch formed on the longer side 401 of the support frame is A, the length from the center portion of the support frame longer side 401 to the corner portion 404 of the support frame circumference is B, the notch 403a on the support frame longer side 401 is formed on a position having the A/B ratio 0.10˜0.16 in forming of the support frame circumference 405 in order to disperse efficiently the stress concentrated on the corner portion of the support frame, accordingly the present invention can prevent the damage of the corner portion of the support frame circumference.

In addition, the length from the support frame corner portion 404 to the notch 403b formed on the shorter side 402 of the support frame is C, the length from the center portion of the support frame shorter side 402 to the corner portion 404 of the support frame circumference is D, the notch 403b on the shorter side 402 of the support frame is formed on a position having the C/D ratio 0.08˜0.18 in order to disperse efficiently the stress concentrated on the corner portion of the support frame, accordingly the present invention can prevent the damage of the corner portion of the support frame circumference.

In addition, after constructing the notches as described above, heat expansion of the support frame occurred in use of the cathode-ray tube is absorbed by the notches of the corner portions, accordingly doming due to the heat expansion of the support frame can be reduced.

Herein, in the width W of the notch 403a formed on the longer side 401 of the support frame, it is set as a W/B ratio=0.02˜0.04 about the length B from the center portion of the support frame longer side 401 to the corner portion 404 of the support frame circumference, in the width W′ of the notch 403b formed on the shorter side 402 of the support frame, it is set as a W′/D ratio=0.02˜0.06 about the length D from the center portion of the shorter side 402 of the support frame to the corner portion 404 of the support frame circumference, accordingly the widths of the notches 403a, 403b can be optimized.

In addition, in the depth d of the notch 403a formed on the support frame longer side 401, when the height on the center portion of the support frame longer side 401 is E, h=E−d, and the height on the corner portion 404 of the support frame circumference is H, d/H ratio is set as 0.05˜0.20, h/E ratio is set as 0.60˜ 0.70, accordingly the depth of the notch 403a can be optimized.

In addition, in the depth d′ of the notch 403b formed on the support frame shorter side 402, when the height on the center portion of the support frame shorter side 402 is F and h′=F−d′, d′/H ratio is set as 0.05˜0.20, h′/F ratio is set as 0.70˜0.75, accordingly the depth of the notch 403b can be optimized.

The notches 403a, 403b can be embodied various shapes such as a circular shape, elliptical shape, square shape, triangular shape etc.

As described above, the support frame for the cathode-ray tube in accordance with the present invention is capable of preventing the damage of the corner portion of the support frame circumference, and reducing the doming due to the heat expansion of the support frame by dispersing efficiently the stress concentrated on the corner portion of the support frame by forming the plurality of the notches on a certain position of the corner portion of the support frame circumferences.

As the present invention may be embodied in several forms without departing from the spirit or essential characteristics thereof, it should also be understood that the above-described embodiments are not limited by any of the details of the foregoing description, unless otherwise specified, but rather should be constructed broadly within its sprit and scope as defined in the appended claims, and therefore all changes and modifications that fall within the meets and bounds of the claims, or equivalence of such meets and bounds are therefore intended to be embraced by the appended claims.

What is claimed is:

1. A support frame for a cathode-ray tube for supporting a shadow mask of a cathode-ray tube, wherein a plurality of notches are formed on a certain upper position of a corner portion of the circumference of the support frame in order to prevent damage on the corner portion of the support frame circumference in forming of the verge of the support frame circumference.

2. The support frame for the cathode-ray tube according to claim 1, wherein the plurality of the notches are separately formed on a longer side and a shorter side of the support frame circumference.

3. The support frame for the cathode-ray tube according to claim 2, wherein the plurality of the notches are separately formed on a position having a A/B ratio 0.10˜0.16 and a position having a C/D ratio 0.08˜0.18 when the length from the corner portion of the support frame circumference to the notch formed on the longer side of the support frame is A, the length from the center portion of the longer side of the support frame to the corner portion of the support frame circumference is B, the length from the support frame corner portion to the notch formed on the shorter side of the support frame is C, and the length from the center portion of the shorter side of the support frame to the corner portion of the support frame circumference is D.

4. The support frame for the cathode-ray tube according to claim 3, wherein the notch has a W/B ratio 0.02˜0.04 when the width of the notch formed on the longer side of the support frame is W, and the notch has a W′/D ratio 0.02˜0.06 when the width of the notch formed on the shorter side of the support frame is W′.

5. The support frame for the cathode-ray tube according to claim 3, wherein the plurality of the notches have the d/H ratio 0.05˜0.20, h/E ratio 0.60˜ 0.70, d′/H ratio 0.05˜0.20, h′/F ratio 0.70˜0.75 when the depth of the notch formed on the longer side of the support frame is d, the height of the center portion of the support frame is E, E−d=h, the depth of the notch formed on the shorter side of the support frame is d′, the height of the center portion of the shorter side of the support frame is F, F−d′=h′, and the height of the corner portion of the support frame circumference is H.
